(19) United States
(12) Patent Application Publication
(10) Pub. No.: US 2022/0020290 A1
(43) Pub. Date: Jan. 20, 2022

(54) EDUCATIONAL S.T.E.M. TOY TO EXPLORE THE RELATIONSHIP OF PRESSURE, VOLUME, AND TEMPERATURE

(71) Applicant: Gershon Parent, Port Orchard, WA (US)

(72) Inventor: Gershon Parent, Port Orchard, WA (US)

(21) Appl. No.: 16/931,241

(22) Filed: Jul. 16, 2020

(51) Int. Cl. G09B 23/12

(52) U.S. Cl. CPC G09B 23/12

(57) ABSTRACT

An educational toy kit that can be assembled into a simple device that translates changes in the volume of gas trapped in a rigid container with a flexible membrane into the movement of a graduated indicator. The changes in gas volume can be created by changes in ambient pressure, as in when changing altitude or temperature and thus can be used to observe the inherent relationship of a gas' volume to its temperature and pressure as governed by the Universal Gas Law (PV=nRT) for the purpose of education and entertainment.

### BACKGROUND OF THE INVENTION

The field of the invention is an educational toy, and in particular, a kit that can be used by a child to assemble a device used to explore the relationship between air pressure, air temperature and air volume.

It is well known that the volume of a gas changes with temperature and pressure according to the ideal gas law, often written in the form PV=nRT, where P is pressure, V is volume, n is number of moles of gas, R is the universal gas constant, and T is temperature. (see https://en.wikipedia.org/wiki/Ideal gas law). Many apparatus have been designed to convert the change in volume of a gas in response to changes in pressure into the movement of a needle or slide indicator to accurately monitor the change and assign values to various pressures or volumes. These devices are the basis of many tools such as weather predictors, blood-pressure cuffs, tire-pressure readers, pressure indicators on gas cylinders, airplane altimeters, etc. and they typically use the expansion or contraction of the gas to move a membrane or piston and then translate that movement into the rotation of a needle indicator. Unfortunately these devices are usually expensive, often fragile, and designed for use in a particular application such as meteorology, medicine or aviation, offer no insight into their mechanism of operation, and are not readily available to children for the purpose of education. Also, these barometers do not offer the opportunity for simple assembly from a kit form to enhance the understanding of the operation and the associated insights into the universal gas law. These devices are primarily designed for accuracy rather than ease of assembly and educational value.

With the advent of S.T.E.M (https://en.wikipedia.org/wiki/Science, technology, engineering, and mathematics) and its focus on educational kits and devices to enhance learning, an inexpensive and simple to use barometer kit enabling one to assemble a working barometer and conduct experiments involving temperature, and weather is needed. The kit can also include instructions for assembly and use, relevant curriculum material, and activities and experiments that can be conducted in the home, in a classroom, or in vehicles such as cars, trucks, trains, airplanes, helicopters, etc.

### BACKGROUND ART

| | | |
|---|---|---|
| 6,561,810 | Schellhardt, et al. | May 13, 2003 |
| 6,106,302 | Schumacher | Aug. 22, 2000 |
| 5,785,278 | Bejtlich, III | Jul. 28, 1998 |
| 5,720,618 | Scarpetti | Feb. 24, 1998 |
| 5,154,615 | Joubert | Oct. 13, 1992 |
| 7,476,103 | Norman | Jan. 13, 2009 |
| 7,350,414 | Nunes, et al. | Apr. 1, 2008 |
| 5,016,473 | Bonello | May 21, 1991 |
| 4,543,824 | Marterer | Oct. 1, 1985 |
| 4,238,958 | Dostmann | Dec. 16, 1980 |
| 4,133,209 | Holtam, et al. | Jan. 9, 1979 |
| 3,940,991 | Gunttner | Mar. 2, 1976 |
| 5,067,902 | Phillips | Nov. 26, 1991 |

### SUMMARY OF THE INVENTION

A kit includes a rigid or semi-rigid container with a volume of approximately 200-500 cubic centimeters with a single opening that allows gas to easily flow in or out (optionally this container can be sourced separately such as a recycled soda can or water bottle). A flexible membrane such as a latex and a means to affix the membrane to the container in such a way that gas cannot flow in or out of the container such as a rubber band so that changes in volume of the gas will cause the membrane to flex. A support structure that can be affixed to the container that supports a needle indicator that rotates from its base and a rigid piston that is in contact with the membrane and in contact with the needle so that when the membrane moves, the piston translates and the needle rotates. The support structure additionally has a means to affix a stiff paper or plastic card to create a dial on which can be drawn graduated markings to associate numbers with the motion of the needle.

### BRIEF DESCRIPTION OF THE DRAWINGS

FIG. 1 is a perspective view of the kit parts before assembly.

FIG. 2 is a perspective view of the assembled toy.

FIG. 3 is a front view of the assembled toy.

FIG. 4 is a perspective view of the container in three different states of pressure and volume.

FIG. 5 is a perspective view of the kit partially assembled.

FIG. 6 is a detail view of the support structure point of connection to the container.

FIG. 7 is a schematic view of an alternative embodiment.

### DESCRIPTION OF THE DRAWINGS

In the drawings, the same reference character denotes the same element in each of the views.

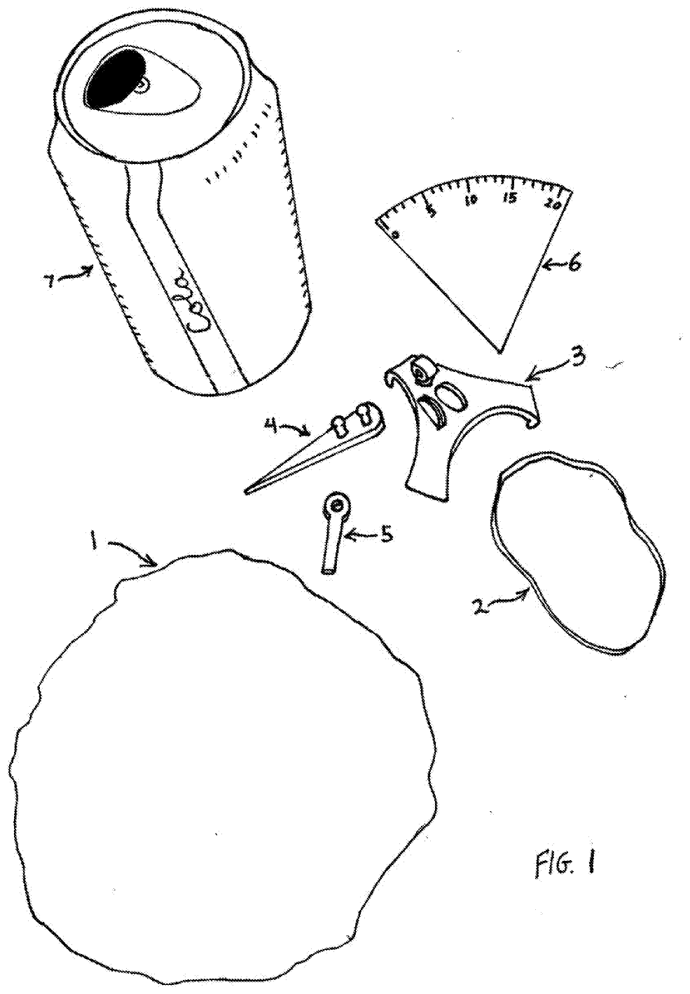

FIG. 1 is a first embodiment of the kit in an unassembled state showing flexible membrane 1, rubber band 2, support structure 3, indicator needle 4, piston 5, paper dial 6, and a container 7.

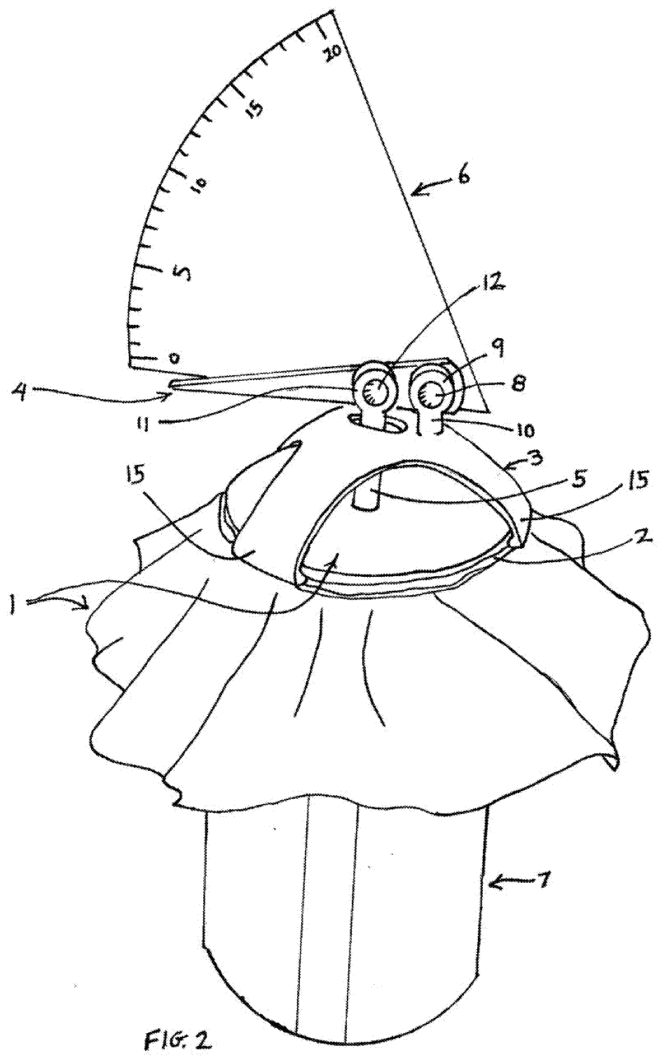

FIG. 2 is the kit of FIG. 1 assembled with the membrane 1 in its neutral position wherein the trapped gas has neither expanded or contracted and so the membrane is not flexed. This figure also shows how the needle 4 is connected to the support structure 3 by means of a pin 8 on the needle 4 that is captured by a hole 9 on a post 10 extending from the support structure 3. It also shows how piston 5 is attached to needle 4 by means of a hole 11 at one end that fits over peg 12 on needle 4.

It also shows how support structure 3 is connected to container 7 by means of three feet 15 which grab the edges of the container by means of a small amount of flex in the support structure 3, a bump on the inside of foot 15 which catches on the lip on the container 7.

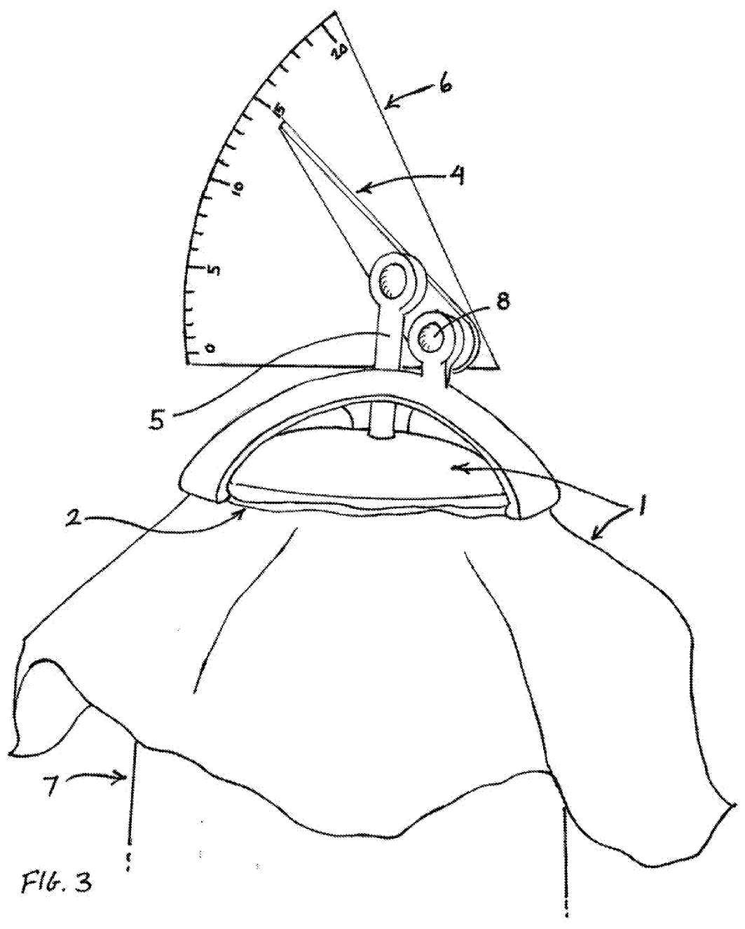

FIG. 3 is the assembled kit from FIG. 2 with the gas of the can 7 having expanded since the membrane 1 was affixed (due to temperature or atmospheric pressure change) causing the piston 5 to rise and cause the needle 4 to rotate to a new position about peg 8.

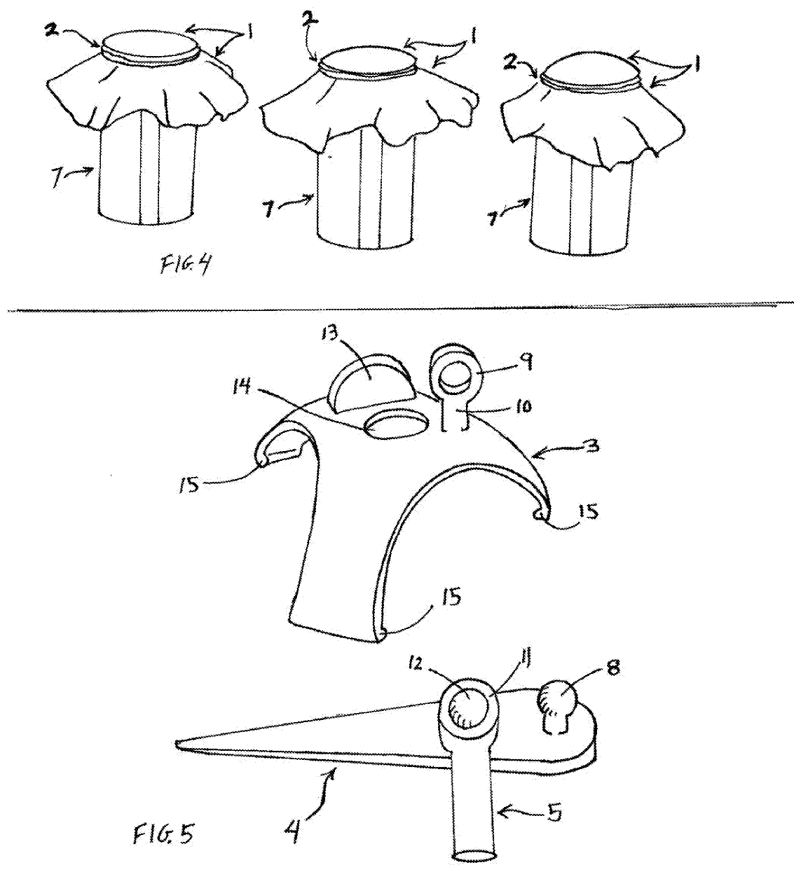

FIG. 4 shows three views of the kit from FIG. 2 partially assembled (with the membrane 1 affixed using the rubber band 2 and support structure 3 removed for clarity). The movement of the membrane 1 due to change in the volume of gas inside the container 7 in three different states of expansion can be seen.

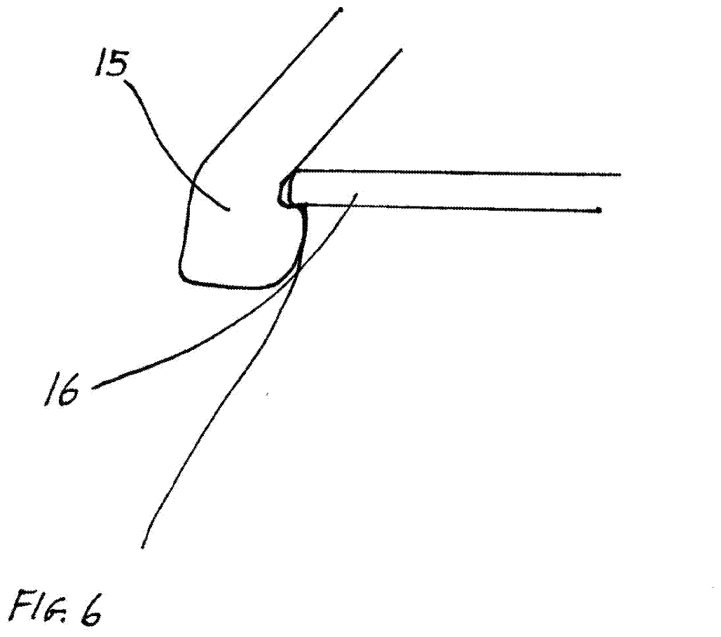

FIG. 5 is the support structure 3 and needle 4 with piston 5 attached to show more detail regarding a means of attachment of the needle 4 to the piston via peg 12 on needle 4 into hole 11 on piston 5 and the peg 8 at the base of the needle 4 that fits into the hole 9 on the post 10 on support structure 3. It also shows the paper-dial support nub 13 which has a slot in it to support the paper dial 6.

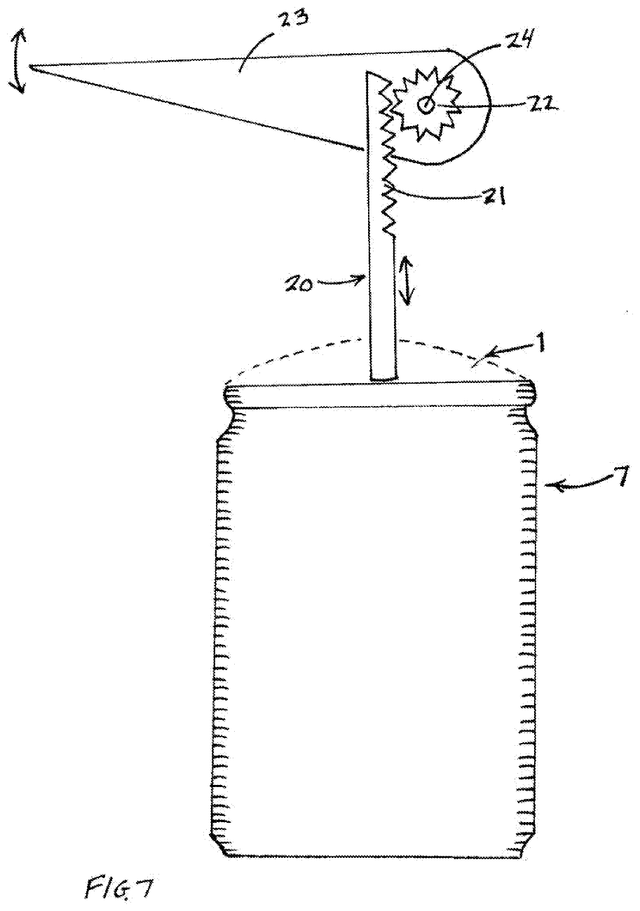

FIG. 6 is a detail photograph of the support structure 3 attached to container 7 with membrane and rubber band removed for clarity to show the contours of foot 15 that enable a firm grasp of the support structure 3 of container 7 by means of the lip 16 on the container at three points to enable a rigid connection between the support structure 3 and the container 7.

FIG. 7 is a schematic drawing showing an alternative means of transforming the motion of the membrane 1 into the rotation of the needle 4 by means of a rack-and-pinion style linkage consisting of a piston 20 having a rack of teeth 21 which engage with gear 22 that is rigidly attached to needle 23 which can rotate freely about point 24. Support structure is not shown for clarity but would include surfaces to ensure the piston 20 stays in contact with gear 22 so as to consistently translate its linear motion into the rotation of needle 23.

Thus, a novel educational toy for the exploration of the relationship of pressure, volume, and temperature has been shown and described.

Various changes and substitutions may of course be made without departing from the spirit and scope of the invention. The invention, therefore, should not be limited, except to the following claims and their equivalents.

1. An educational toy, comprising:
a container;
a flexible membrane and means to attach it to the container;
an indicator that is mechanically coupled to the flexible membrane in such a way that it moves in response to the movement of the membrane.

2. The educational toy of claim 1 wherein the flexible membrane will move in response to changes in pressure as is caused by weather and changes in altitude.

3. The educational toy of claim 1 wherein the flexible membrane will move in response to changes in temperature.

4. The educational toy of claim 1 wherein the toy comes in kit form and is easy to assemble by a child or adult.
